(19) United States
(12) Patent Application Publication
(10) Pub. No.: US 2001/0048818 A1
(43) Pub. Date: Dec. 6, 2001

(54) Scanning apparatus and digital film processing method

(76) Inventor: Robert S. Young JR., Austin, TX (US)

Correspondence Address: DINSMORE & SHOHL, LLP, 1900 CHEMED CENTER, 255 EAST FIFTH STREET, CINCINNATI, OH, 45202, US

(21) Appl. No.: 09/751,403

(22) Filed: Dec. 29, 2000

Related U.S. Application Data
(60) Provisional application No. 60/174,128, filed on Dec. 31, 1999.

(51) Int. Cl. G03D 3/00

(52) U.S. Cl. 396/564

(57) ABSTRACT

A method of developing a latent image on an exposed photographic element by applying a developer solution to the photographic element and scanning the photographic element with at least two different wavelengths of electromagnetic radiation while the latent image is developing. A method of electronically developing a latent image on exposed film, and a digital film scanning apparatus for use in electronic film development are also provided.

### RELATED APPLICATIONS

This application claims priority under 35 U.S.C. § 119(e) of U.S. Provisional Patent Application No. 60/174,128, entitled Scanning Apparatus and Digital Film Processing Method, Attorney Docket Number 24012-33 (ASF98062), and having a filing date of Dec. 30,1999.

This application is related to the following copending United. States patent applications: System and Method for Digital Film Development Using Visible Light, Ser. No. ______, Attorney Docket Number 021971.0154 (ASF99286), and having a priority filing date of Dec. 30, 1999; Improved System and Method for Digital Film Development Using Visible Light, Ser. No. ______, Attorney Docket Number 021971.0161 (ASF99324), and having a priority filing date of Dec. 30, 1999; Method and System for Capturing Film Images, Ser. No. ______, Attorney Docket Number ASF00005, and having a priority filing date of Feb. 3, 2000; and System and Method for Digital Dye Color Film Processing, Ser. No. ______, Attorney Docket Number ASF00143.

### FIELD OF THE INVENTION

The present invention relates to scanning apparatus and digital film processing methods. More particularly, the present invention provides a scanning apparatus and a digital film processing method wherein two or more distinct wavelengths of light are used during digital film processing.

### BACKGROUND OF THE INVENTION

In traditional film photography, the photographic film includes one or more layers of a photosensitive material (typically silver halide). When a picture is taken, the light from the scene interacts with the film's photosensitive material to produce a chemical change in the photosensitive material. This chemical change is in direct proportion to the intensity of the light. The greater the intensity of light from the scene, the greater the chemical change in the photosensitive material. As described in greater detail below, the photographic film is then chemically developed in order to produce an image based on the chemical change.

Conventional black and white photographic film generally has a single layer of silver halide emulsion coated on a transparent film support. Color photographic film generally includes multiple layers of silver halide in combination with dye forming coupling agents (“couplers”). Each silver halide layer in color photographic film is sensitive to a different portion of the visible spectrum. Typically, color film includes one or more silver halide layers sensitized to each of blue, green and red portions of the visible spectrum, and the coupler in each layer is capable of forming a dye of a color which is complimentary to the color of light to which the layer is sensitized. For example, a silver halide layer which is sensitized to blue light will include a coupler associated with the formation of a yellow dye.

In traditional chemical development processes, the exposed film is developed using a developing agent. The developing agent chemically reduces the exposed silver halide to elemental silver. The amount of elemental silver produced in any given area of the film corresponds to the intensity of light which exposed that area. Those areas of the silver halide where the light intensity was the greatest will have the greatest amount of elemental silver produced. In contrast, in those areas of the silver halide where the light intensity was low, a very small amount of elemental silver is produced. The pattern of elemental silver thus forms an image in the silver halide layers.

During the traditional chemical development process, the highlight areas of the image (e.g., areas of the film which were exposed to the greatest intensity of light) will develop before those areas of the film which were exposed to a lower intensity of light (such as areas of the film corresponding to shadows in the original scene). A longer development time allows shadows and other areas of the film, which were exposed to a low intensity of light to be more fully developed, thereby providing more detail in these areas. However, a longer development time will also reduce details and other features in the highlight areas of the image. Thus, the development time in a traditional chemical development process is typically chosen as a compromise between highlight details, shadow details and other features of the image which are dependant upon the duration of development. After development, in the case of black and white photographic film, the image is fixed by dissolving the undeveloped silver halide. The developed negative can then be used to produce a corresponding positive image on photographic paper by methods well known to those skilled in the art.

In the case of conventional color photographic film development, elemental silver is formed in the silver halide layers as described above. After the developing agent has reduced the exposed silver halide to elemental silver, the oxidized developing agent reacts with the couplers in the film to produce dye clouds around the grains of elemental silver in each of the layers. The color of the dye clouds in each layer of the film is complementary to the color of light the layer has been sensitized to. For example, the red sensitive layer typically produces cyan dye clouds, the green layer produces magenta dye clouds, and the blue layer produces yellow dye clouds. At this point, each layer of the color film includes both a silver image and a dye cloud image. The elemental silver and undeveloped silver halide are then removed from the film by bleaching and fixing, leaving only a dye image in each layer of the film. Since the dye in each emulsion layer is formed in an imagewise manner, the developed film will generally have yellow, magenta and cyan colored negative images in the blue, green, and red-sensitive emulsion layers, respectively. The color negative can then be used to produce a corresponding positive image on photographic paper by methods known to those skilled in the art.

The negative, or the corresponding positive image, can also be digitized using a conventional electronic scanner to produce a digital representation of the image. Scanning of negative images on film is typically accomplished by passing visible light through the developed negative. Light transmitted through the film is attenuated by developed silver (black and white film) or by the dye layers (color film), thereby allowing one to capture and record a digital representation of the image. The transmitted light is then passed through filters having appropriate spectral sensitivities such that the densities of the yellow, magenta and cyan dyes may be detected for each location on the film. The density values detected in this way are indirect measures of the blue, green and red light that initially exposed each location on the film These measured density values constitute three values used as the blue, green and red values for each corresponding location, or pixel, in the digital image. Further processing of these pixel values is often performed to produce a digital image that accurately reproduces the original scene and that is pleasing to the human eye.

A relatively new process for developing film is digital film processing (“DFP”). Digital film processing digitizes, i.e., electronically scans, the silver image during the development process. The elemental silver image developed in each of the layers of the photographic film is used to construct a digital image of the scene photographed. The developing film is scanned with infrared (“IR”) light so that the scanning light will not fog the film. In the case of conventional color negative film, the IR light is not attenuated by the dyes formed in the film during development. The image can be scanned at different times during the development process in order to acquire additional information from the photographic film. The digitized images are then electronically processed to determine the colors associated with each location. The resulting digital image can then be printed or manipulated, as desired.

### SUMMARY OF THE INVENTION

One embodiment of the present invention provides a method of developing a latent image on an exposed photographic element by applying a developer solution to the photographic element and scanning the photographic element with at least two different wavelengths of electromagnetic radiation while the latent image is developing. In one embodiment, the electromagnetic radiation comprises first and second wavelengths of infrared light. In another embodiment, the electromagnetic radiation comprises visible and infrared light.

In one embodiment, the scanning step generally comprises: directing light of the first wavelength at a first surface of the photographic element; directing light of the second wavelength at a second surface of the photographic element; detecting light of the first wavelength reflected away from the first surface and light of the first wavelength transmitted through the photographic element; and detecting light of the second wavelength reflected away from the second surface. The scanning step may further include detecting light of the second wavelength which is transmitted through the photographic element. In addition, light of the first wavelength and light of the second wavelength may be simultaneously directed at the photographic element. Scanning may be performed at one or more predetermined times after application of the developer solution.

Another embodiment of the present invention provides a method of electronically developing a latent image on exposed film by applying a developer solution to the film thereby developing the latent image on the film; and scanning the film during development with light of at least two different wavelength bands.

An improved digital film scanning apparatus for use in electronic film development is also provided. The scanning apparatus may comprise: a first source of electromagnetic radiation configured for directing radiation of a first wavelength at film; a second source of electromagnetic radiation configured for directing radiation of a second wavelength at film; a plurality of first optical sensors which are responsive to radiation of the first wavelength and are substantially unresponsive to radiation of the second wavelength; and a plurality of second optical sensors which are responsive to radiation of the second wavelength and are substantially unresponsive to radiation of the first wavelength.

A digital film processing system for use in electronic film development is also provided, wherein the system comprises: a developer supply station configured for applying a developer solution to the film; and at least one scanning apparatus for scanning the film with two different wavelengths of light after application of the developer solution.

### BRIEF DESCRIPTION OF THE DRAWINGS

FIG. 1 is a schematic illustration of a scanning device in accordance with the embodiment of the present invention; and

FIG. 2 is a schematic illustration of a digital film processing method in accordance with one embodiment of the present invention.

### DETAILED DESCRIPTION OF THE INVENTION

As described in greater detail below, the present invention provides a digital film processing (“DFP”) method, as well as a scanning device which may be used in DFP. Exposed film is chemically developed in order to form scene images composed of grains of elemental silver in each of the light sensitive layers of the film. While the film is developing, it is scanned using electromagnetic radiation of two or more distinct wavelengths. At least two electromagnetic radiation sources are generally used, with one positioned in front and one in back of the film. The radiation from these sources is attenuated by the amount of elemental silver developed at each spot on the film. In an embodiment using visible light, the light is also attenuated by the dye images in the film. The attenuated radiation is detected and converted to digital signals using appropriate optical and electronic systems. Based on the amount of detected radiation, one embodiment of the present invention produces three values, referred to as front, back, and through data, for each pixel on the film. These signals are directly related to the grains of elemental silver that form the scene image. By scanning the film with two or more distinct wavelengths of electromagnetic radiation, three or more of the “channels” (e.g., front, back and through) can be acquired simultaneously. For example, back-through data can be acquired simultaneously with back data. In another embodiment, the film is scanned with visible light having two or more distinct wavelengths of electromagnetic radiation. In this embodiment, the different wavelengths can be recorded simultaneously using a filter or such other device or software operable to distinguish the different wavelength signals.

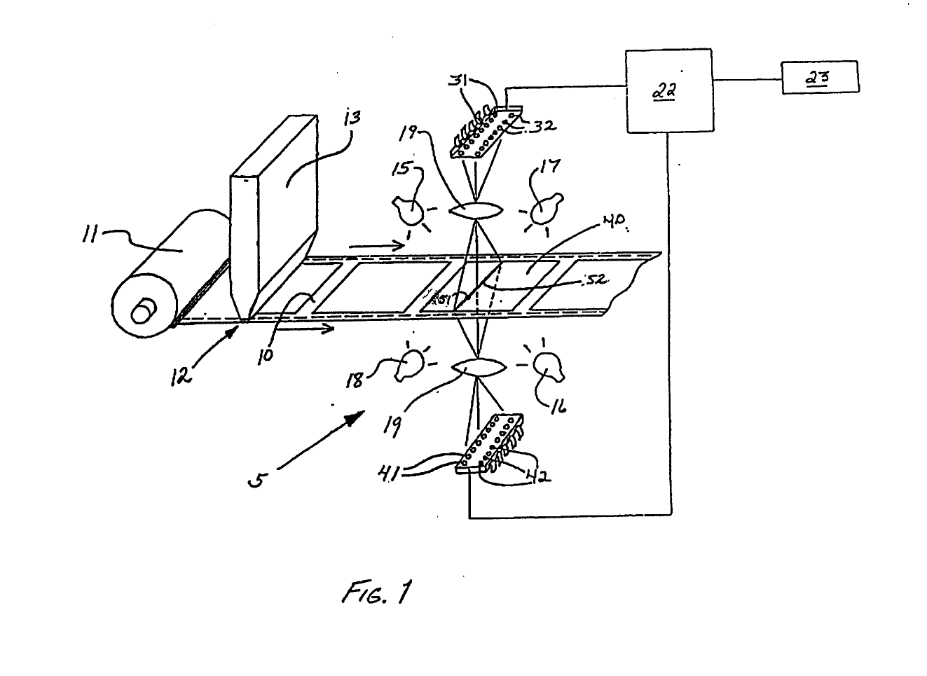

FIG. 1 is a schematic representation of one embodiment of an improved digital film scanning apparatus 5 which may be used, for example, in DFP. The digital film scanning apparatus 5 of FIG. 1 may in turn be part of a larger optical and electronic system. The scanning apparatus 5 operates by converting electromagnetic radiation attenuated by an image into an electronic (digital) representation of the image. The image being scanned is typically embodied in a physical form, such as on a photographic media (e.g., film 10 in cartridge 11), although other media may be used. In many applications, the electromagnetic radiation used to convert the image into a digitized representation is infrared light; however, visible light and particular colors of visible light, as well as other suitable types of electromagnetic radiation may also be used to produce the digitized image.

In particular, different colors of light interact differently with the film 10. Visible light interacts with the dyes and silver within the film 10. Whereas, infrared light interacts with the silver, but the dyes are generally transparent to infrared light. The term “color” is used to generally describe specific frequency bands of electromagnetic radiation, including visible and non-visible light. Visible light, as used herein, means electromagnetic radiation having a frequency or frequency band generally within the electromagnetic spectrum of near infrared light (>700 nm) to near ultraviolet light (<400 nm). Visible light can be separated into specific bandwidths. For example, the color red is generally associated with light within a frequency band of approximately 600 nm to 700 nm, the color green is generally associated with light within a frequency band of approximately 500 nm to 600 nm, and the color blue is generally associated with light within a frequency band of approximately 400 nm to 500 nm. Near infrared light is generally associated with radiation within a frequency band of approximately 700 nm to 1500 nm. Although specific colors and frequency bands are described herein, the film 10 may be scanned with other suitable colors and frequency ranges without departing from the spirit and scope of the invention.

Scanning apparatus 5 of FIG. 1 may be employed in a DFP method to process an exposed photographic element, such as film 10 in cartridge 11. Film 10 can comprise any of a variety of photographic films having one or more light sensitive silver halide emulsion layers. For example, film 10 can comprise conventional color negative film, or even color positive or reversal film. Conventional color negative film generally has at least three silver halide emulsion layers, with at least one layer sensitized to each of blue, green and red light. Although couplers are typically included in each of the light sensitive emulsion layers of conventional color negative film, the methods of the present invention allow for the elimination of these couplers in the film. When IR light is used for scanning, the dyes formed by these couplers generally do not attenuate the IR light.

After image wise exposure, film 10 is subjected to digital film processing in accordance with the methods of the present invention. Film 10 is advanced from cartridge 11 through a developer supply station 12, whereat a developer solution is applied to film 10. Developer solution may be applied at station 12 by any of a variety of means. For example, developer solution may be applied from a pod as a viscous fluid under a clear cover film, as described in U.S. Pat. No. 5,465,155 (“the '155 patent”, which is incorporated herein by way of reference). Alternatively, the developer solution may be applied using the apparatus and methods described in U.S. Pat. No. 5,988,896. In the embodiment shown in FIG. 1, the developer solution is applied as a viscous fluid from slot coater 13 having an elongate slot positioned above, and extending across the width of, film 10. The developer solution is forced through the elongate slot of slot coater 13 onto film 10.

The developer solution may comprise a developing agent capable of converting the exposed silver halide to elemental silver, such as developing agents used in conventional film developing. In particular, a C-41 developer solution may be used as the basis for a developing agent used in the present invention. The developer solution may be aqueous, and may be maintained at an alkaline pH. In addition to the developing agent, the developer solution can include various other additives well-known to those skilled in the art. Suitable additives include, for example, various preservatives (e.g., sodium sulfite, sodium bisulfite, sodium metabisulfate or potassium metabisulfate), accelerators (e.g., potassium or sodium carbonate, potassium or sodium hydroxide, borax, or sodium metaborate), restrainers (such as potassium bromide), and antifoggants (such as benzotriazole or 6-nitrobenzimidazole nitrate).

At a predetermined time after application of the developer solution, film 10 is scanned using scanning apparatus 5 of FIG. 1. In an embodiment using infrared light to avoid fogging the film 10, film 10 is subjected to a reflectance scan from each side (“front” and “back” scans) and at least one transmission scan (“through” scan). At least two sources of electromagnetic radiation are provided in scanning apparatus 5, such as first light source 15 and second light source 16, and these light sources illuminate film 10 containing a scene image 40 from opposite sides of film 10 (i.e., from above and below film 10). First source 15 and second source 16 apply electromagnetic radiation of different wavelengths to film 10. In this embodiment, first source 15 and second source 16 apply different wavelengths of infrared light to film 10. Thus, first source 15 emits radiation of a first wavelength (such as a spectral wavelength or a band of wavelengths), and second source 16 emits radiation of a second wavelength, which is different from the first wavelength. Radiation from sources 15 and 16 may be diffused or directed by additional optics such as filters and/or one or more lenses (not shown).

First and second light sources 15 and 16 may be individually configured to generate light of the desired wavelength (either as a single spectral wavelength or as a band of wavelengths). Alternatively, each light source may emit a broadband of light, and suitable filters (e.g., bandpass filters) or other wavelength limiting devices may be associated with each light source to ensure that the photographic element is scanned with the desired wavelengths of light. As yet another alternative, a single, common light source may be employed along with suitable filters (or other wavelength limiting devices) as well as optics in order to direct the desired wavelengths of light at the front and back surfaces of the photographic element. In another embodiment, first and second light sources 15 and 16 emit a broadband of light and the sensors are filtered to spectrally distinguish between the light signals.

In an embodiment using infrared light, the infrared light from sources 15 and 16 is attenuated by the elemental silver at each spot on the film. In an embodiment using visible light, the visible light from sources 15 and 16 is attenuated by elemental silver and dyes at each spot on the film 10. In another embodiment, visible and infrared light is used to distinguish between the elemental silver and the dyes on the film 10. The attenuated radiation is detected and converted to digital signals using appropriate optical and electronic systems, as further described below. Based on the amount of detected radiation, the values corresponding to the colors red, green and blue can be determined for each pixel on the film 10. For example, in one embodiment of the present invention, front, back and through record is produced for each pixel on the film 10. The front record generally relates to the blue value, the back record generally relates to the red value, and the through record can be used in conjunction with the front and back records to calculate the green value. In an embodiment using visible light, these values are directly related to the elemental silver and dye that forms the image in each layer of the film 10. By using radiation of two different wavelengths, the attenuated radiation from source 15 can be distinguished from the attenuated radiation from source 16 (such as by employing optical sensors capable of distinguishing between the two wavelengths).

When infrared light is used, the above-described scans may be repeated at one or more additional predetermined times after application of the developer solution. For example, image data may be acquired at short, normal and long development times. Scanning may be performed at any number of predetermined times after application of the developer solution. In contrast, conventional film development allows only a single development time, and therefore compromises must be made between, for example, shadow and highlight detail.

Scanning apparatus 5 of FIG. 1 also includes a number of optical sensors, such as sensor elements 31, 32, 41 and 42. The optical sensors measure the intensity of electromagnetic radiation passing through or reflected by film 10. Each optical sensor element generally comprises a photodetector (not expressly shown) that produces an electrical signal proportional to the intensity of electromagnetic energy striking the photodetector. Accordingly, the photodetector measures the intensity of electromagnetic radiation attenuated by image 40 on film 10. The optical sensors may be manufactured from different materials and by different processes such that each is responsive to certain wavelengths of the electromagnetic spectrum. For example, a suitable coating or filter which transmits radiation of only the desired wavelength may be positioned over each sensor.

Optical sensor elements 31, 32, 41 and 42 are configured to be responsive to radiation of either the first or second wavelength. For example, sensors 31 and 41 may be configured to be responsive to radiation of the first wavelength, while being substantially unresponsive to radiation of the second wavelength. Similarly, sensors 32 and 42 may be configured to be responsive to radiation of the second wavelength, while being substantially unresponsive to radiation of the first wavelength.

Any of a variety of light responsive sensor elements may be employed (i.e., any sensor which can generate an electrical signal in response to light). Suitable sensors include phototransistors, photoresistors, charge coupled devices (CCD's), time delay integration arrays (“TDI” arrays), or any other device capable of responding to light. It should be pointed out that the term CCD is typically used generically in the art to refer to a semiconductor sensor array. The sensor may include one or more individual sensor elements, each of which is light responsive. A CCD sensor, for example, will include a one or more individual photosensitive elements, such that each sensor element of the CCD acquires image data corresponding to a discrete, typically very small, region of the image being scanned. A plurality of individual sensor elements may be arranged in an array to allow for the scanning of an entire area of an image at one time. Alternatively, a plurality of individual sensor elements may be arranged in one or more rows such that the CCD sensor will acquire image data on a line by line (rather than area) basis.

The optical sensors are typically housed in a circuit package which is electrically connected (e.g., by a cable) to supporting electronics for computer data storage and processing, shown together as computer 22. Computer 22 can then process the data provided by the optical sensors in order to generate a digitized image. It should be noted that computer 22 need not be separate from the other apparatus used in the methods of the present invention, since a microprocessor may be incorporated into a single apparatus which also includes the scanning stations, and the developer supply station. As noted in FIG. 1, sensor elements 31 and 32 may even be provided as part of the same circuit package, and sensor elements 41 and 42 may likewise be provided as part of the same circuit package.

In the specific embodiment shown in FIG. 1, light source 15 may be positioned on the side of film 10 opposite optical sensors 41 and 42, while light source 16 may be positioned on the side of film 10 opposite optical sensors 31 and 32. Radiation emitted from first source 15 will pass through image 40 on film 10 toward sensors 41, while radiation emitted from second source 16 will pass through image 40 on film 10 toward sensors 32. In addition, radiation emitted from first source 15 will also be reflected from image 40 toward sensors 31, and radiation emitted from second source 16 will similarly be reflected from image 40 toward sensors 42.

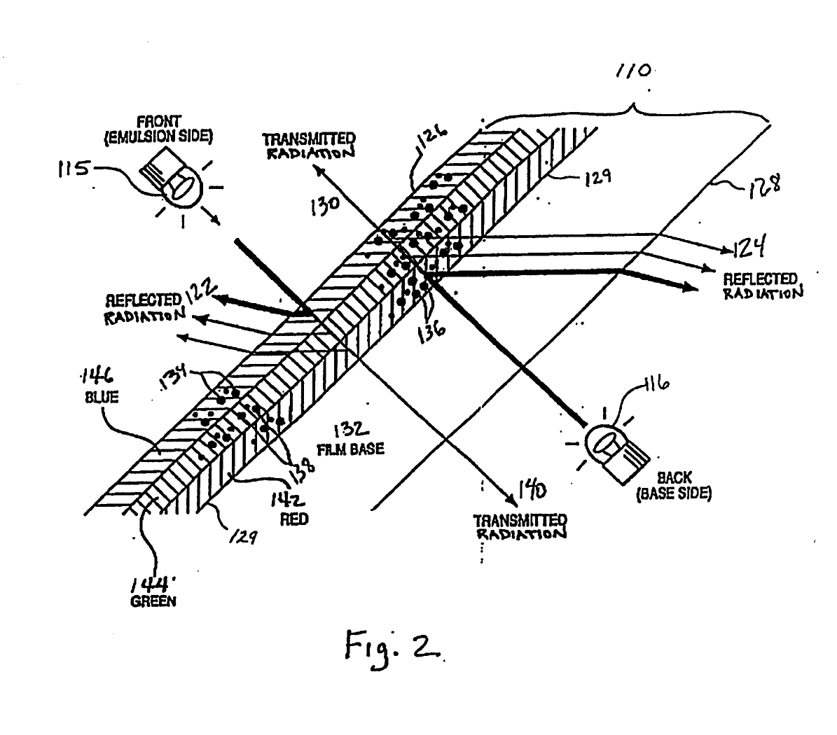

When first source 15 is activated, sensors 31 will detect radiation of the first wavelength reflected by image 40 (“front” data), while sensors 41 will detect radiation of the first wavelength which passes through image 40 (“through” data; more specifically “back-through” data). Similarly, when second source 16 is activated, sensors 42 will detect radiation of the second wavelength reflected by image 40 (“back” data), while sensors 32 will detect radiation of the second wavelength which passes through image 40 (“front-through” data). This process of using two sources positioned on opposite sides of the film being scanned is described in more detail below in conjunction with FIG. 2.

Since sensors 31 and 41 are responsive to radiation of the first wavelength and are substantially unresponsive to radiation of the second wavelength, light from second source 16 (i.e., light of the second wavelength) will not interfere with acquisition of the front and back-through data (at sensors 31 and 41, respectively). Likewise, since sensors 32 and 42 are responsive to radiation of the second wavelength and are substantially unresponsive to radiation of the first wavelength, light from first source 15 (i.e., light of the first wavelength) will not interfere with acquisition of the back and front-through data (at sensors 42 and 32, respectively).

It should be pointed out that only a single through scan may be needed (either back-through or front-through). For example, sensors 32 may be omitted from scanning apparatus 5 such that only front, back and back-through data is acquired for each pixel. Also, one or more additional light sources may be provided, such as third and fourth light sources 17 and 18, respectively. Third light source 17 may be configured to emit radiation of the first wavelength (i.e., the same wavelength as first light source 15), and fourth light source 18 may be configured to emit radiation of the second wavelength (i.e., the same wavelength as second light source 16).

Alternatively, third and fourth light sources 17 and 18 may be configured to emit radiation of one or more additional wavelengths which are different from the first and second wavelengths emitted by sources 15 and 16. In such a configuration, additional optical sensors may be provided, wherein these additional sensors are responsive to radiation of the wavelength(s) emitted by third and fourth sources 17 and 18, and which are substantially unresponsive to radiation of the first and second wavelengths. By way of example, if third light source 17 is configured to emit light of a third distinct wavelength, additional optical sensors which are responsive to the third wavelength and substantially unresponsive to the first and second wavelengths may be positioned adjacent sensors 41 and 42. In this manner, light from third light source 17 can be used to acquire back-through data. Of course any number of additional light sources, wavelengths and corresponding sensors may be used, as desired.

Scanning apparatus 5 may also include one or more lenses 19 positioned between film 40 and each of the optical sensors in order to direct and focus the radiation on the sensors. The optical sensors 31, 32, 41 and 42 are generally geometrically positioned in arrays such that the electromagnetic energy striking each optical sensor corresponds to a distinct location 51 in image 40. Accordingly, each distinct location 51 in the scene image 40 corresponds to a distinct location, referred to as a picture element, or “pixel” for short, in the scanned, or digitized image provided by the scanning system.

As noted in FIG. 1, each set of sensors (e.g., the set comprising sensors 31) may be arranged in a linear array, such that each set of sensors projects back through lens 19 as a line 52 extending vertically across image 40. By scanning across the width of image 40 of film 10 (such as by advancing film 10 in the direction shown by the arrows), each point on image 40 will be scanned with radiation from first and second sources 15 and 16. In order to scan the entire width of image 40, film 10 must be moved perpendicularly to projection line 52, as shown. In this manner, image data will be acquired by the optic sensors on a line by line basis. Alternatively, film 10 may remain stationary and the optical sensors, lenses 19 and light sources 15 and 16 may be moved in order to scan across the width of image 40. Of course other types of sensors may negate the need to advance film 10 in order to scan the entirety of image 40 (such as CCD area sensors), or may necessitate other scanning patterns.

Turning now to FIG. 2 which schematically depicts a DFP method according to the present invention, a conventional color film 110 is depicted. As previously described, the present invention uses duplex film scanning which refers to using a first (or front) source 115 and a second (or back) source 116 to scan film 110 with radiation of two different wavelengths. Each wavelength may comprise a spectral wavelength (e.g., one specific wavelength) or a band of wavelengths. Front source 115 applies radiation of a first wavelength towards front surface 126 of film 110, and a portion of this radiation is reflected away from front surface 126 (reflected radiation 122) and a portion is transmitted through film 110 (transmitted radiation 140). Back source 116 applies radiation of a second wavelength towards back surface 128 of film 110, and a portion of this radiation is reflected away from back emulsion surface 129 (reflected radiation 124) and a portion is transmitted through film 110 (transmitted radiation 130). Thus, reflected radiation 122 and transmitted radiation 140 will comprise the first wavelength, while reflected radiation 124 and transmitted radiation 130 will comprise the second wavelength.

In FIG. 2, separate color levels are viewable within the film 110 during development of the red layer 142, green layer 144 and blue layer 146. Over a clear film base 132 are three layers 142, 144, 146 sensitive separately to red, green and blue light, respectively. These layers are not physically the colors; rather, they are sensitive to these colors. In conventional color film development, the blue sensitive layer 146 would eventually develop a yellow dye, the green sensitive layer 144 a magenta dye, and the red sensitive layer 142 a cyan dye.

During development, layers 142, 144, and 146 are opalescent. Dark silver grains 134 developing in the top layer 146, the blue sensitive layer, are visible from the front 126 of the film, and slightly visible from the back 128 because of the bulk of the opalescent emulsion. Similarly, grains 136 in the bottom layer 142, the red sensitive layer, are visible from the back 128 by reflected radiation 124, but are much less visible from the front 126. Grains 138 in the middle layer 144, the green sensitive layer, are only slightly visible by reflected radiation 122 and 124. However, they are visible along with those in the other layers by transmitted radiation 130 and 140. By sensing radiation reflected away from front 126 and back 129 as well as radiation transmitted through the film 110, each pixel for the film 110 yields three measured values, one from each scan, that may be mathematically processed in a variety of ways to produce the initial three colors, red, green and blue, values closest to the original scene.

The front signal records the radiation 122 reflected from the first illumination source 115 in front of the film 110. The set of front signals for an image is called the front channel. The front channel principally, but not entirely, records the attenuation in the radiation from the first source 115 due to the silver metal particles 134 in the top-most layer 146, which is the blue recording layer. There is also some attenuation of the front channel due to silver metal particles 136 and 138 in the red and green layers 142 and 144, respectively.

The back signal records the radiation 124 reflected from the second illumination source 116 in back of the film 110. The set of back signals for an image is called the back channel. The back channel principally, but not entirely, records the attenuation in the radiation from the second source 116 due to the silver metal particles 136 in the bottom-most layer 142, which is the red recording layer. Additionally, there is some attenuation of the back channel due to silver metal particles 134 and 138 in the blue and green layers 146 and 144, respectively.

The front-through signal records the radiation 130 that is transmitted through the film 110 from the second illumination source 116 in back of the film 110. The set of front-through signals for an image is called the front-through channel. If desired, the back-through signal records the radiation 140 that is transmitted through the film 110 from the first source 115 in front of the film 110. The set of back-through signals for an image is called the back-through channel. Both through channels record essentially the same image information since they both record the attenuation of the radiation 130, 140 due to the silver metal particles 134, 136, 138 in all three red, green, and blue recording layers 142,144, 146 of the film 110.

Several image processing steps are required to convert the illumination source radiation information for each channel to the red, green, and blue values similar to those produced by conventional scanners for each spot on the film 110. These steps are required because the silver metal particles 134, 136, 138 that form during the development process are not spectrally unique in each of the film layers 142, 144, 146. These image processing steps are not performed when conventional scanners are used because the silver is removed during conventional chemical color processing of the film. However, just as with conventional scanners, once initial red, green and blue values are derived for each image, further processing of the red, green, and blue values is usually done to produce images that more accurately reproduce the original scene and that are pleasing to the human eye.

It is intended that the description of the present invention provided above is but one embodiment for implementing the invention. Variations in the description likely to be conceived of by those skilled in the art still fall within the breadth and scope of the disclosure of the present invention. While specific alternatives to steps of the invention have been described herein, additional alternatives not specifically disclosed but known in the art are intended to fall within the scope of the invention. Thus, it is understood that other applications of the present invention will be apparent to those skilled in the art upon the reading of the described embodiment and a consideration of the appended claims and drawings.

What is claimed is:

1. A method of developing a latent image on an exposed photographic element, comprising:
(a) applying a developer solution to said photographic element; and
(b) scanning said photographic element with at least two different wavelength bands of electromagnetic radiation while said latent image is developing.

2. The method of claim 1, wherein the at least two wavelength bands include visible and infrared light.

3. The method of claim 1, wherein at least one wavelength band comprises infrared light.

4. The method of claim 3, wherein said scanning step comprises:
directing light of said first wavelength at a first surface of said photographic element;
directing light of said second wavelength at a second surface of said photographic element;
detecting light of said first wavelength reflected away from said first surface; and
detecting light of said second wavelength transmitted through said second surface.

5. The method of claim 4, wherein said second wavelength includes infrared light.

6. The method of claim 1, wherein light of a first wavelength and light of a second wavelength are simultaneously directed at said photographic element.

7. The method of claim 1, wherein said scanning is performed at a first predetermined time after application of said developer solution.

8. The method of claim 1, wherein said scanning is performed at multiple predetermined times after application of said developer solution.

9. A method of electronically developing a latent image on exposed film, comprising:
applying a developer solution to the film; and
scanning said coated film simultaneously with light of at least two different wavelengths.

10. The method of claim 9, wherein said scanning step comprises directing light of a first wavelength at a first surface of said film, directing light of a second wavelength at a second surface of said film, and detecting light reflected away from said first and second surfaces and light transmitted through said film.

11. The method of claim 9, wherein said film is scanned at a multiple times during development.

12. The method of claim 9, wherein said light comprises infrared light.

13. The method of claim 9, wherein said light comprises visible light.

14. The method of claim 13, wherein said visible light comprises the wavelengths of red and green light.

15. The method of claim 13, wherein said light also comprises infrared light.

16. The method of claim 9, wherein said light comprises red, green and blue light.

17. The method of claim 9, wherein said light comprises red, blue and infrared light.

18. An improved digital film scanning apparatus for use in electronic film development, the apparatus comprising:
a first source of electromagnetic radiation configured for directing radiation of a first wavelength at film;
a second source of electromagnetic radiation configured for directing radiation of a second wavelength at film;
a plurality of first optical sensors which are responsive to radiation of said first wavelength and are substantially unresponsive to radiation of said second wavelength; and
a plurality of second optical sensors which are responsive to radiation of said second wavelength and are substantially unresponsive to radiation of said first wavelength.

19. The improved digital scanning apparatus of claim 18, further comprising a developer supply station configured for applying a developer solution to said film.

20. The improved digital scanning apparatus of claim 18, wherein said first wavelength is within the visible portion of the electromagnetic spectrum, and said second wavelength is within the infrared portion of the electromagnetic spectrum.

21. The improved digital scanning apparatus of claim 18, wherein said first wavelength comprises the colors red, green and blue light, and said second wavelength comprises infrared light.

22. The improved digital scanning apparatus of claim 18, wherein said first and second optical sensors measure radiation of said first and second wavelength transmitted through the film.
